(19) United States
(12) Patent Application Publication
(10) Pub. No.: US 2023/0408698 A1
(43) Pub. Date: Dec. 21, 2023

(54) TIME-OF-FLIGHT SENSOR AND METHOD FOR MEASURING DISTANCE

(71) Applicant: STMicroelectronics (Grenoble 2) SAS, Grenoble (FR)

(72) Inventors: Thibault Augey, Grenoble (FR); Jeremie Teyssier, Grenoble (FR)

(21) Appl. No.: 18/334,501

(22) Filed: Jun. 14, 2023

(30) Foreign Application Priority Data
Jun. 14, 2022 (FR) 2205763

(51) Int. Cl. G01S 17/89; G01S 7/481

(52) U.S. Cl. CPC G01S 17/89; G01S 7/4816

(57) ABSTRACT

A time-of-flight sensor includes a light emitting device configured to emit light rays toward a scene and a photosensitive pixel matrix configured to receive light signals reflected from the scene and to generate an image that includes dots associated with the light signals reflected from the scene. Each dot covers a number of pixels of the image. A processing unit is configured to, for each dot of the image, partition the pixels of the dot into at least one group of pixels and, for each group of pixels, compute a representative value of distance values of the pixels of this group. The representative distance value can then be applied to each pixel of the group of pixels.

### CROSS-REFERENCE TO RELATED APPLICATIONS

This application claims the benefit of French Application No. 2205763, filed on Jun. 14, 2022, which application is hereby incorporated herein by reference.

### TECHNICAL FIELD

Embodiments and implementations relate to time-of-flight sensors and method for measuring distance.

### BACKGROUND

A time-of-flight sensor is a sensor for measuring distances between this sensor and elements of a scene wherein this sensor is placed. The time-of-flight sensor is configured to emit light rays in the scene. These light rays can be reflected by the different elements of the scene. Moreover, the time-of-flight sensor can include a photosensitive pixel matrix. Each photosensitive pixel of the matrix is configured to detect incident light signals on this pixel. Each pixel thus makes it possible to detect the light rays emitted by the sensor and then reflected by the different elements. The detection of rays reflected by a pixel of the matrix enables the time-of-flight sensor to compute a distance between the sensor and the elements of the scene having reflected the light rays. The time-of-flight sensor then generates an image of the scene defining, for each pixel of the image, a distance between the sensor and an element of the scene.

Some time-of-flight sensors use a dot projector. The image thus generated by the time-of-flight sensor includes a plurality of dots, each dot covering several pixels. These dots correspond to the pixels of the matrix detecting the rays emitted by the sensor which are reflected by the elements of the scene. Such time-of-flight sensors make it possible to reduce interference associated with ambient light in the scene. The local concentration of the light at each dot makes it possible to enhance distance determining performances.

It is known to compute a mean value of the distances associated with the pixels of the same dot. This mean distance value is then associated with this dot of the image.

A dot of the image may comprise pixels delivering distance values for different elements of the scene disposed at different distances from the sensor. In this case, the sensor associates with the dot a mean computed distance value which can correspond to a distance for which no element may actually be present in the scene. The value associated with this dot is thus incorrect. Such a time-of-flight sensor is therefore relatively unreliable under certain conditions and does not make it possible to detect several elements on the same dot of the image.

### SUMMARY

Embodiments can provide a reliable time-of-flight sensor under the aforementioned conditions.

According to an aspect, a time-of-flight sensor comprises an emitting device configured to emit light rays in a scene where the time-of-flight sensor is placed. A photosensitive pixel matrix is configured to receive light signals from the scene and to generate an image illustrating dots associated with the rays emitted by the emitting device, reflected by elements of the scene, and received by the pixel matrix. Each dot covers a plurality of pixels of the image. A processing unit is configured to, for each dot of the image, partition the pixels of this dot into at least one group of pixels and compute, for each group of pixels, a representative value of the distance values of the pixels of this group. This representative distance value can then be applied for each pixel of the group of pixels.

Such a time-of-flight sensor makes it possible to isolate the dots of the image from the other, then define groups of pixels for each dot of the image according to the distance values thereof. The groups of a dot of the image can then be associated with the presence of different elements of the scene.

Thus, such a time-of-flight sensor makes it possible to detect several elements of the scene located on the same dot of the image, and to return, for this dot of the image, the same number of distance values as elements on this dot.

Such a time-of-flight sensor also makes it possible to limit distance value errors associated with certain pixels of a dot of the image. Indeed, grouping pixels having distance values close to one another can make it possible to extract the pixels having deviating distance values. By not accounting for pixels having deviating distance values, the signal-to-noise ratio of such a sensor is enhanced.

Such a time-of-flight sensor is therefore reliable and precise.

In an advantageous embodiment, the processing unit is also configured to merge groups of pixels of the same dot if the difference of the representative values computed for these groups of pixels is less than a given threshold, then to compute a new representative distance value for the new group of pixels formed by merging these groups. In this way, the processing unit makes it possible to avoid having several groups associated with the presence of the same element of the scene.

Preferably, the partitioning of the pixels of each dot includes an implementation of a segmentation algorithm, for example, a partitioning algorithm into k-means.

According to a further aspect, a method is proposed for measuring distances between a time-of-flight sensor and elements of a scene wherein the time-of-flight sensor is placed. The method comprises emission of light dots in the scene by an emitting device of the time-of-flight sensor, reception by a pixel matrix of the time-of-flight sensor of the light signals from the scene, and generation by the pixel matrix of an image illustrating dots associated with the rays emitted by the emitting device, reflected by elements of the scene and received by the pixel matrix, each dot covering a plurality of pixels of the image. For each dot of the image, the pixels of this dot are partitioned into at least one group of pixels. For each group of pixels, a representative value of the distance values of the pixels of this group is computed. This representative distance value is then applied for each pixel of the group of pixels.

Advantageously, the method further comprises merging of the groups of pixels of the same dot if the difference of the representative values computed for these groups of pixels is less than a given threshold, then computing of a new representative distance value for the new group formed by merging these groups.

Preferably, the partitioning of the pixels of each dot includes an implementation of a segmentation algorithm, particularly a partitioning algorithm into k-means.

### BRIEF DESCRIPTION OF THE DRAWINGS

Further advantages and features of the invention will emerge on studying the detailed description of embodiments, which are in no way restrictive, and of the appended drawings wherein:

FIG. 1 illustrates a time-of-flight sensor;

FIG. 2 illustrates an example of an image IMG capable of being generated by a pixel matrix;

FIG. 3 illustrates a dot in the image of FIG. 2;

FIGS. 4 and 5 illustrate a dot in the image of FIG. 2 after some processing; and

FIG. 6 illustrates a method for processing an image generated by a pixel matrix of a time-of-flight sensor.

### DETAILED DESCRIPTION OF ILLUSTRATIVE EMBODIMENTS

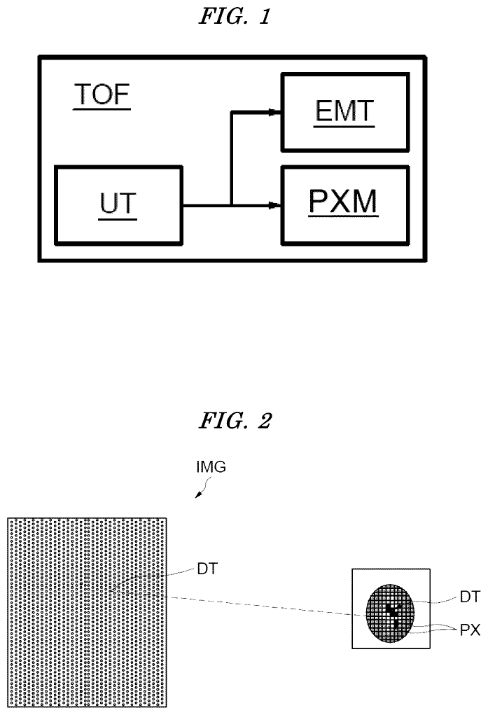

FIG. 1 illustrates a time-of-flight sensor TOF. This time-of-flight sensor TOF can be an indirect time-of-flight sensor (also known as “iTOF”). The time-of-flight sensor TOF includes an emitting device EMT and a pixel matrix PXM. The time-of-flight sensor TOF also includes a control and processing unit UT configured to control the emitter EMT and the pixel matrix PXM.

The emitting device EMT is configured to emit light rays in a scene where the sensor TOF is placed. These light rays are then reflected by the different elements of the scene to the pixel matrix PXM. The emitting device EMT can be any light emitting device such as a laser, a light emitting diode (LED) or a LIDAR, as but three examples.

The pixel matrix PXM is configured to detect the light signals received thereby. The pixel matrix PXM can be, for example, photodetector such as a photodiode, an avalanche photodiodes, a single-photon avalanche diode (SPAD), or any other solid-state photodetector

The pixel matrix PXM is thus configured to generate images IMG of the scene using the light signals detected thereby. FIG. 2 illustrates an example of an image IMG capable of being generated by the pixel matrix PXM. The image is composed of pixels PX associated with the different pixels of the pixel matrix PXM.

Each pixel PX of the image IMG is associated with a distance value measured between the time-of-flight sensor CPT and an element of the scene.

Each image IMG shows a set of dots DT corresponding to the different rays reflected by the elements of the scene and picked up by the pixel matrix PXM. Each dot DT of the image IMG covers a set of pixels PX of the image. For example, a dot DT of the image IMG can cover a set of 10×10 pixels.

FIG. 2 illustrates the distance values of the pixels of a dot DT of the image.

The processing unit UT is configured to process each image IMG generated by the pixel matrix PXM. In particular, the processing unit UT is configured to partition the pixels PX for each dot DT of the image IMG. Thus, for each dot DT of the image IMG, the processing unit UT is configured to define at least one group of pixels PX associated with this dot DT.

In particular, for each dot DT of the image IMG, the processing unit UT is configured to group the pixels PX of the dot DT having distance values that are close to one another. This makes it possible to identify different elements of the scene represented on the same dot of the image. For example, pixels PX can be considered to be close enough to be grouped together in the same group if the difference between the distance values thereof is less than 2% of the mean of the two distances (this 2% value being a parameter of the algorithm which can be adjusted according to the performances of the time-of-flight sensor).

Obviously, different partitioning algorithms can be used to define the groups of pixels PX of a dot DT of the image IMG. For example, the groups can be defined by a partitioning algorithm into k-means. Alternatively, the groups can be defined by a histogram analysis of the distance values of the pixels PX of the dot DT of the image so as to detect the local maxima to identify the different elements of the scene represented on the dot DT.

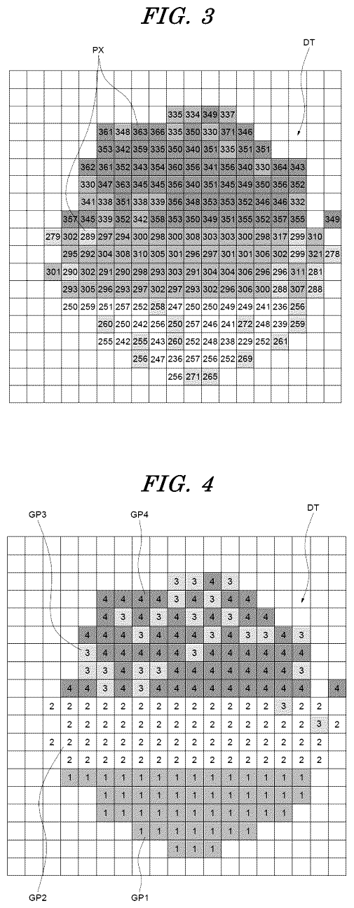

FIG. 3 illustrates the dot DT in FIG. 2. The pixels having close distance values can be grouped in groups GP1, GP2, GP3, GP4 as shown in FIG. 4.

For each dot DT of the image, the processing unit is configured to compute for each group a representative value of the distance values of pixels PX of this group. This representative value of a group can be a mean value of the distance values of pixels PX of this group.

If two groups of the same dot DT have representative values close to one another, the processing unit can be configured to merge these two groups. For example, representative values can be considered to be close when the difference thereof is less than 2% of the mean of the two distances (this 2% value being a parameter of the algorithm which can be adjusted according to the performances of the time-of-flight sensor). The processing unit is then configured to compute a new representative value for the new group formed resulting from merging the two groups. For example, FIG. 5 illustrates the dot in FIG. 2 wherein the groups GP3 and GP4 of pixels have been merged so as to form a new group NGP3 of pixels.

The processing unit thus generates a final image wherein the dots DT of the initial image have as distance values the representative values computed for each group defined for each dot DT.

Such a time-of-flight sensor makes it possible to detect several elements of the scene located on the same dot DT of the image, and to return, for this dot DT of the image, the same number of distance values as elements on this dot DT.

Such a time-of-flight sensor also makes it possible to limit distance value errors associated with certain pixels PX of a dot DT of the image. Indeed, grouping pixels PX having distance values close to one another can make it possible to extract the pixels PX having deviating distance values. By not accounting for pixels PX having deviating distance values, the signal-to-noise ratio of such a sensor is enhanced.

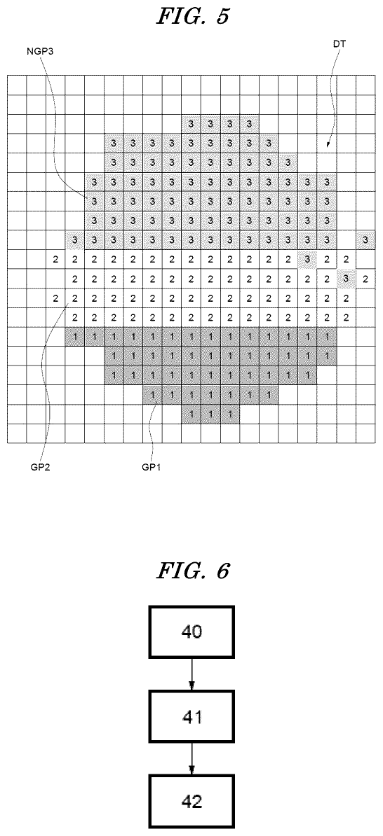

FIG. 6 illustrates a method for processing an image generated by a pixel matrix PXM of a time-of-flight sensor as described above. As seen above, the image generated by the pixel matrix PXM includes several dots DT.

The method includes an implementation of an algorithm (40) for partitioning the pixels PX of each dot DT. The implementation of such an algorithm (40) makes it possible to define groups of pixels PX in each dot DT of the image.

The method also includes, for each group of each dot DT, computing of a representative value (41) of the distance values of the pixels PX of this group.

The method can also comprise merging of the groups (42) of the same dot DT having representative values that are close to one another. The method then comprises, following the merging of the groups, computing of a new representative value for the new group formed resulting from merging these groups.

What is claimed is:

1. A time-of-flight sensor comprising:
a light emitting device configured to emit light rays toward a scene;
a photosensitive pixel matrix configured to receive light signals reflected from the scene and to generate an image that includes dots associated with the light signals reflected from the scene, each dot covering a plurality of pixels of the image;
a processing unit configured to:
for each dot of the image, partition the pixels of the dot into at least one group of pixels;
for each group of pixels, compute a representative value of distance values of the pixels of this group; and
apply the representative distance value for each pixel of the group of pixels.

2. The time-of-flight sensor according to claim 1, wherein the processing unit is further configured to create a merged group of pixels by merging groups of pixels of the same dot when a difference of the representative values computed for the groups of pixels is less than a given threshold.

3. The time-of-flight sensor according to claim 2, wherein the given threshold is 2% of a mean of the representative values.

4. The time-of-flight sensor according to claim 2, wherein the processing unit is further configured to compute a new representative distance value for the merged group of pixels.

5. The time-of-flight sensor according to claim 1, wherein the processing unit is configured to partition the pixels of each dot by implementation of a segmentation algorithm.

6. The time-of-flight sensor according to claim 5, wherein the segmentation algorithm is a partitioning algorithm into k-means.

7. The time-of-flight sensor according to claim 1, wherein the processing unit is configured to partition the pixels of each dot by implementation of a histogram analysis.

8. The time-of-flight sensor according to claim 1, wherein the processing unit is configured to partition by grouping pixels that have distance values less than 2% of a mean of the distances of the pixels.

9. The time-of-flight sensor according to claim 1, wherein the processing unit is further configured to, for a group of the pixels, remove a pixel having a distance value that deviates from distance values of other pixels in the group.

10. The time-of-flight sensor according to claim 1, wherein each dot of the image comprises a set of 10×10 pixels.

11. A method for measuring distances between a time-of-flight sensor and elements of a scene wherein the time-of-flight sensor is placed, the method comprising:
emitting light rays toward the scene;
receiving light signals reflected from the scene at a pixel matrix of the time-of-flight sensor;
generating an image illustrating dots associated from the received light signals;
for each dot of the image, partitioning the pixels of the dot into groups of pixels;
for each group of pixels, computing a representative value of the distance values of the pixels of the group, the representative distance value then being applied for each pixel of the group of pixels.

12. The method according to claim 11, further comprising forming a merged group by merging groups of pixels of the same dot that have a difference of the representative values less than a given threshold and computing a new representative distance value for the merged group.

13. The method according to claim 12, wherein the given threshold is 2% of a mean of the representative values.

14. The method according to claim 11, wherein partitioning the pixels of each dot into groups of pixels comprises implementing a segmentation algorithm.

15. The method according to claim 14, wherein the segmentation algorithm is a partitioning algorithm into k-means.

16. The method according to claim 11, wherein partitioning the pixels of each dot into groups of pixels comprises performing a histogram analysis of distance values of the pixels of each dot.

17. The method according to claim 11, wherein partitioning the pixels into groups of pixels comprises grouping pixels that have distance values less than 2% of a mean of the distances of the pixels.

18. The method according to claim 11, further comprising, for a group of the pixels, removing a pixel having a distance value that deviates from the distance values of other pixels in the group.

19. The method according to claim 11, wherein each dot of the image comprises a set of 10×10 pixels.
